(19) United States
(12) Patent Application Publication
(10) Pub. No.: US 2025/0079064 A1
(43) Pub. Date: Mar. 6, 2025

(54) TRANSFORMER

(71) Applicant: LITE-ON TECHNOLOGY CORPORATION, Taipei (TW)

(72) Inventors: Chen CHEN, Taipei (TW); Bo-Ruei CIOU, Taipei (TW); De-Jia LU, Taipei (TW)

(21) Appl. No.: 18/611,760

(22) Filed: Mar. 21, 2024

(30) Foreign Application Priority Data
Aug. 28, 2023 (TW) 112132309

(51) Int. Cl. H01F 27/28; H01F 27/00

(52) U.S. Cl. CPC H01F 27/28; H01F 27/006

(57) ABSTRACT

A transformer includes a magnetic core, a primary winding set, a first secondary winding set and a second secondary winding set. The magnetic core has an upper cover, a lower cover and a first winding post, and the first winding post is located between the upper cover and the lower cover. The primary winding set is wound around the first winding post. The first secondary winding set is wound around the first winding post and located at one side of the primary winding set. The second secondary winding set is wound around the first winding post and located on another side of the primary winding set. The second secondary winding set is electrically connected to the first secondary winding set to form a center-tapped structure.

This application claims the benefit of Taiwan application Serial No. 112132309, filed Aug. 28, 2023, the subject matter of which is incorporated herein by reference.

### BACKGROUND OF THE INVENTION

### Field of the Invention

The invention relates in general to an electronic device, and more particularly to a transformer.

### Description of the Related Art

In order to be suitable for high-voltage use, conventional transformers must increase the turns ratio between the primary winding set and the secondary winding. In addition, the ferrite core of a conventional transformer is provided with a plurality of ribs at intervals, and a primary winding set and two secondary windings of positive and negative half cycles are wound on the ferrite core in slots through one of the ribs. However, due to the leakage inductance between the first and second secondary winding sets and the primary winding set, this type of split-slot transformer causes a high coupling coefficient difference and is not suitable for use in a center-tapped transformer architecture. In addition, the current difference between the positive and negative half cycles of this type of split-slot transformer is too large, resulting in increased copper loss.

### SUMMARY OF THE INVENTION

The present invention relates to a transformer that can balance the coupling coefficient between the primary winding set and the first and second secondary winding sets, and make the wave peaks of the DC power output in the positive and negative half cycles similar to improve current flow problem.

According to one aspect of the present invention, a transformer including a magnetic core, a primary winding set, a first secondary winding set and a second secondary winding set is provided. The magnetic core has an upper cover, a lower cover and a first winding post, and the first winding post is located between the upper cover and the lower cover. The primary winding set is wound around the first winding post. The first secondary winding set is wound around the first winding post and is located on one side of the primary winding set. The second secondary winding set is wound around the first winding post and is located on another side of the primary winding set. The second secondary winding set and the first secondary winding set are electrically connected and form a center-tapped structure.

According to one aspect of the present invention, a transformer including a magnetic core, a primary winding set, a first secondary winding set and a second secondary winding set is provided. The magnetic core has an upper cover, a lower cover, a first winding post and a second winding post. The first winding post and the second winding post are located between the upper cover and the lower cover. The primary winding set is wound around the first winding post. The first secondary winding set is wound around the first winding post or the second winding post and is located on one side of the primary winding set. The second secondary winding set is wound around the first winding post or the second winding post and is located on another side of the primary winding set. The second secondary winding set and the first secondary winding set are electrically connected and form a center-tapped structure.

According to one aspect of the present invention, a transformer including a magnetic core, a primary winding set, a first secondary winding set and a second secondary winding set is provided. The magnetic core has an upper cover, a lower cover, a first winding post, a second winding post and a third winding post. The first winding post, the second winding post and the third winding post are located between the upper cover and the lower cover. The primary winding set is wound around the second winding post. The first secondary winding set is wound around the first winding post and is located on one side of the primary winding set. The second secondary winding set is wound around the third winding post and is located on another side of the primary winding set. The second secondary winding set and the first secondary winding set are electrically connected and form a center-tapped structure.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of the appearance of a transformer according to an embodiment of the present invention.

FIG. 2 is a waveform diagram of the current output by a transformer in the positive and negative half cycles according to an embodiment of the present invention.

FIGS. 3A and 3B are respectively schematic diagrams of a winding structure of a transformer and a corresponding transformer circuit according to an embodiment of the present invention.

FIG. 4 is a schematic view of the appearance of a transformer according to another embodiment of the present invention.

FIG. 5 is a schematic cross-sectional view of a winding structure of a transformer according to an embodiment of the present invention.

FIG. 6 is a schematic cross-sectional view of a winding structure of a transformer according to another embodiment of the present invention.

FIG. 7 is a schematic cross-sectional view of a winding structure of a transformer according to another embodiment of the present invention.

FIG. 8 is a schematic cross-sectional view of a winding structure of a transformer according to another embodiment of the present invention.

FIG. 9 is a schematic cross-sectional view of a winding structure of a transformer according to another embodiment of the present invention.

FIG. 10 is a schematic cross-sectional view of a winding structure of a transformer according to another embodiment of the present invention.

FIG. 11 is a schematic cross-sectional view of a winding structure of a transformer according to another embodiment of the present invention.

### DETAILED DESCRIPTION OF THE INVENTION

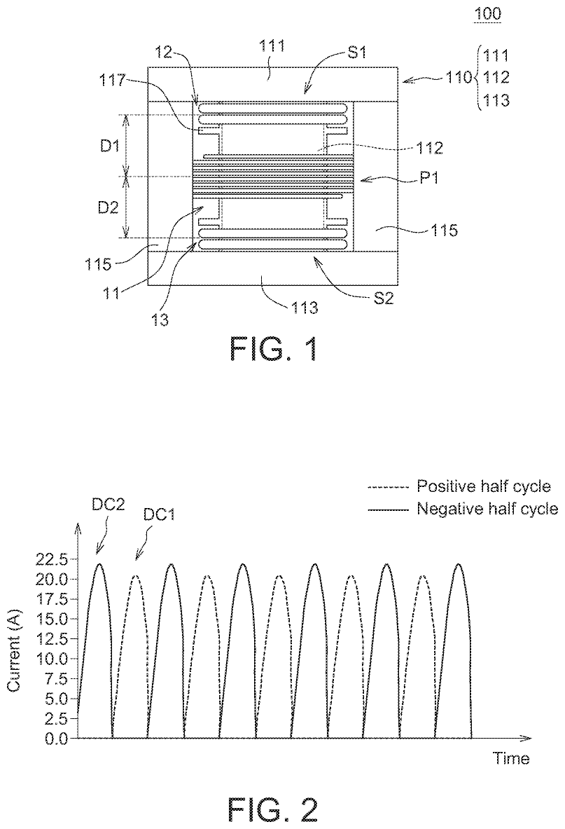

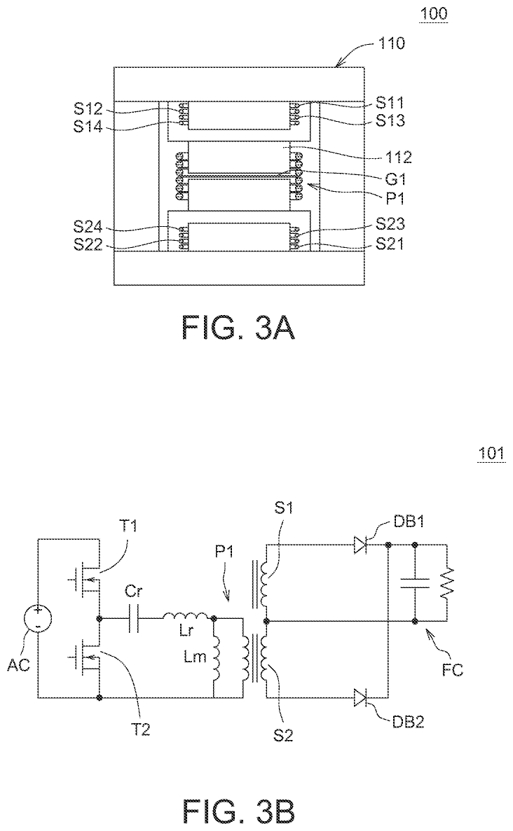

Refer to FIGS. 1 and 2. FIG. 1 is a schematic diagram of the appearance of a transformer 100 according to an embodiment of the present invention, and FIG. 2 is a waveform diagram of the current output by a transformer 100 in the positive and negative half cycles according to an embodiment of the present invention. The transformer 100 of this embodiment can be used in a center-tapped half-bridge rectifier circuit (see FIG. 3B) to balance the coupling coefficients between the first and second secondary winding sets S1 and S2 and the primary winding set P1 to improve the current flow problem. However, the transformer 100 of this embodiment can also be used in other types of rectifier circuits, and the present invention is not limited thereto. In the following embodiments, the same/similar components are represented by the same or similar reference symbols.

Referring to FIG. 1, the transformer 100 includes a magnetic core 110, a primary winding set P1, and first and second secondary winding sets S1 and S2. The magnetic core 110 has an upper cover 111, a lower cover 113 and a first winding post 112. The first winding post 112 is located between the upper cover 111 and the lower cover 113. The first secondary winding set S1 is wound around the first winding post 112 and is located on one side of the primary winding set P1. The second secondary winding set S2 is wound around the first winding post 112 and is located on another side of the primary winding set P1. The second secondary winding set S2 and the first secondary winding set S1 are electrically connected and form a center-tapped structure (see FIG. 3B).

In one embodiment, the first winding post 112 has an air gap G1 (see FIG. 3A), and the primary winding set P1 overlaps the air gap G1. In addition, the transformer 100 may include a winding frame 117. The winding frame 117 is sleeved on the first winding post 112 and has a first accommodation area 11, a second accommodation area 12 and a third accommodation area. The first accommodation area 11 is located between the second accommodation area 12 and the third accommodation area 13. The primary winding set P1 can be wound in the first accommodation area 11, the first secondary winding set S1 can be wound in the second accommodation area 12, and the second secondary winding set S2 can be wound in the third accommodation area 13. In one embodiment, the upper cover 111, the lower cover 113 and the side cover 115 of the magnetic core 110 surround the first winding post 112 to form an accommodation space for accommodating the first winding post 112, the primary winding P1 and the first and second secondary winding sets S1 and S2 inside the magnetic core 110. The above components can be configured inside the magnetic core 110 in a closed or semi-open manner.

In one embodiment, the primary winding set P1 is wound around the first winding post 112 or the winding frame 117, and the number of turns of the primary winding set P1 is greater than the number of turns of the first and second secondary winding sets S1 and S2. In addition, the first and second secondary winding sets S1 and S2 are wound around the first winding post 112 or the winding frame 117, and the first secondary winding set S1 has a first spacing D1 (e.g., center-to-center) from the primary winding set P1 in the extending direction of the first winding post 112, and the second secondary winding set S2 has a second spacing D2 (e.g., center-to-center) from the primary winding set P1 in the extending direction of the first winding post 112. That is to say, the first and second secondary winding sets S1 and S2 are respectively located on the upper and lower sides of the primary winding set P1, and the ratio of the first spacing D1 to the second spacing D2 is greater than or equal to 0.9 and less than or equal to 1.1, so that the coupling coefficients between the first and second secondary winding sets S1, S2 and the primary winding set P1 remain consistent. In one embodiment, the turns ratio of the primary winding set P1 to the first and second secondary winding sets S1 and S2 is, for example, 33:2:2, but the invention is not limited thereto.

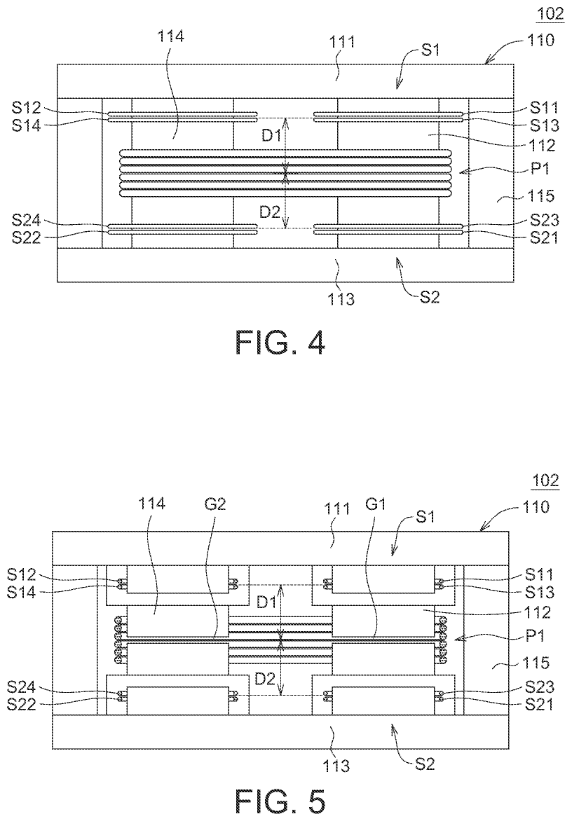

The function of the transformer 100 is to use the principle of electromagnetic induction to increase or decrease the alternating current to an appropriate alternating current voltage at the load end. The winding structure is two sets of coils, insulated from each other and wound around one, two or three winding posts. The coil connected to the alternating current is called the primary winding set P1 (primary coil), and the coil connected to the load end is called the first and second secondary winding sets S1 and S2 (secondary coils). When the alternating current is connected to the primary winding set P1, A change in magnetic flux will be generated and transmitted to the first and second secondary winding sets S1 and S2 through the winding post, and the change in magnetic flux causes the first and second secondary winding sets S1 and S2 to generate alternating current. The AC voltage generated by the first and second secondary winding sets S1 and S2 is proportional to the number of turns of the transformer 100, that is, V1/V2=N1/N2. Therefore, the alternating current at the load end can be obtained by changing the turns ratio of the transformer 100. In addition, the AC power at the load end can also form a ripple-shaped DC power through the filter circuit FC and the rectified current (including the rectifier diodes DB1 and DB2) (see FIG. 4). That is to say, the first and second secondary winding sets S1 and S2 are electrically connected to the rectifier circuit.

Refer to FIG. 2. Looking at the waveform diagram of the DC output in the positive and negative half cycles, after rectification, a peak value of the direct current output DC1 in the positive half cycle is approximately 20.31 amps, and a peak value of the direct current output DC2 in the negative half cycle is approximately 21.86 amps, and the difference between the two peak values is 1.55 amps. It can be seen that the transformer 100 of this embodiment arranges the first and second secondary winding sets S1 and S2 respectively on both sides of the primary winding set P1, so that the peak values of the direct current output DC1 and DC2 in the positive and negative half cycles are similar to improve the current flow problem.

Referring to FIGS. 3A and 3B, schematic diagrams of a winding structure of the transformer 100 and a corresponding transformer circuit 101 according to an embodiment of the present invention are respectively illustrated. In one embodiment, the transformer circuit 101 may include a power supply AC, a plurality of metal oxide semiconductor field effect transistors T1 and T2, a resonant circuit (including a resonant capacitor Cr and a resonant inductor Lr), a primary winding set P1, first and second secondary winding sets S1 and S2, a half-bridge rectifier circuit (rectifier diodes DB1, DB2) and a filter circuit FC. The power supply AC is used to output an alternating current, and the primary winding set P1 is used to connect the alternating current to generate a resonant inductor Lr and a magnetizing inductor Lm. When the alternating current is connected to the primary winding set P1, a change in magnetic flux will be generated and transmitted to the first and second secondary winding sets S1 and S2 through the winding post. The half-bridge rectifier circuit includes two rectifier diodes DB1 and DB2, which are respectively connected between the corresponding first and second secondary winding sets S1 and S2 and the filter circuit FC. During the positive half cycle of the AC output, the rectifier diode DB1 located on the upper side is forward biased to allow the current to pass, while the rectifier diode DB2 located on the lower side is reverse biased to prevent the current from passing. On the contrary, during the negative half cycle of the AC output, the rectifier diode DB1 located on the upper side is reverse biased to prevent the current from passing, while the rectifier diode DB2 located on the lower side is forward biased to allow the current to pass. Therefore, the current passing through the first and second secondary windings S1 and S2 can generate a direct current after being rectified by the half-bridge rectifier circuit.

Referring to FIG. 3A, in one embodiment, the first secondary winding set S1 located on the upper side includes parallel-connected first sub-windings S11, S13 and parallel-connected second sub-windings S12, S14. The parallel-connected first sub-windings S11, S13 and the parallel-connected second sub-windings S11, S13 are connected in parallel and staggered to each other. In addition, the second secondary winding set S2 located on the lower side includes parallel-connected third sub-windings S21, S23 and parallel-connected fourth sub-windings S22, S24. The parallel-connected third sub-windings S21, S23 and the parallel-connected fourth sub-windings S22, S24 are connected in parallel and staggered to each other.

Refer to FIG. 4. A schematic diagram of the appearance of a transformer 102 according to another embodiment of the present invention is illustrated. The transformer 102 includes a first winding post 112, a second winding post 114, a primary winding set P1, and first and second secondary winding sets S1 and S2. The first winding post 112 and the second winding post 114 are parallel to each other and separated by a distance. The primary winding set P1 is wound around at least one of the first winding post 112 and the second winding post 114, and the first and second secondary windings S1 and S2 are wound around at least one of the first winding post 112 and the second winding post 114 and are arranged on both sides of the primary winding set P1. In one embodiment, the accommodation space surrounded by the same magnetic core 110 can accommodate two sets of primary winding sets P1 and the first and second secondary winding sets S1 and S2 at the same time. The primary winding set S1 may have first sub-windings S11, S13 and second sub-windings S12, S14 respectively wound around the first winding post 112 and the second winding post 114, while the second secondary winding set S2 located on the lower side may have third sub-windings S21, S23 and fourth sub-windings S22, S24 respectively wound around the first winding post 112 and the second winding post 114.

That is to say, the first and second secondary winding sets S1 and S2 are respectively located on the upper and lower sides of the primary winding set P1, and the first secondary winding set S1 located on the upper side has a first spacing D1 from the primary winding set P1 in the extension direction of the first winding post 112 or the second winding post 114, while the second secondary winding set S2 located on the lower side has a second spacing D2 from the primary winding set P1 in the extension direction of the first winding post 112 or the second winding post 114. The ratio of the first spacing D1 to the second spacing D2 is greater than or equal to 0.9 and less than or equal to 1.1, so that the coupling coefficients between the first and second secondary winding sets S1 and S2 and the primary winding set P1 remain constant. In one embodiment, the turns ratio of the primary winding set P1 to the first and second secondary winding sets S1 and S2 is, for example, 33:2:2, but the invention is not limited thereto.

The transformer 102 of this embodiment can be used in a center-tapped half-bridge rectifier circuit to balance the coupling coefficients between the first and second secondary winding sets S1, S2 and the primary winding set P1 to improve the current flow problem. In addition, the first winding post 112 and the second winding post 114 are respectively provided with a first air gap G1 and a second air gap G2 (see FIG. 5). The primary winding set P1 may be arranged to overlap or not overlap with the first air gap G1 and/or the second air gap G2, and the present invention is not limited thereto.

For example, in the transformer 102 of FIG. 5, the first secondary winding set S1 located on the upper side includes parallel-connected first sub-windings S11, S13 and parallel-connected second sub-windings S12, S14. The first sub-windings S11 and S13 are wound around the first winding post 112, and the parallel second sub-windings S12 and S14 are wound around the second winding post 114. That is to say, the first winding post 112 and the second winding post 114 respectively have parallel-connected first sub-windings S11 and S13 and parallel-connected second sub-windings S12 and S14. In addition, the second secondary winding set S2 located on the lower side includes parallel-connected third sub-windings S21 and S23 and parallel-connected fourth sub-windings S22 and S24. The parallel-connected third sub-windings S21 and S23 are wound around the first winding post 112, and the parallel-connected fourth sub-windings S22 and S24 are wound around the second winding post 114.

In addition, the primary winding set P1 can be wound around the first winding post 112 and the second winding post 114. The first sub-windings S11, S13 and the second sub-windings S12, S14 respectively have a first spacing D1 from the primary winding set P1. The third sub-windings S21, S23 and the fourth sub-windings S22, S24 respectively have a second spacing D2 from the primary winding set P1, and the ratio of the first spacing D1 to the second spacing D2 is greater than or equal to 0.9 and less than or equal to 1.1, so that the coupling coefficients between the first and second secondary winding sets S1, S2 and the primary winding set P1 remain consistent.

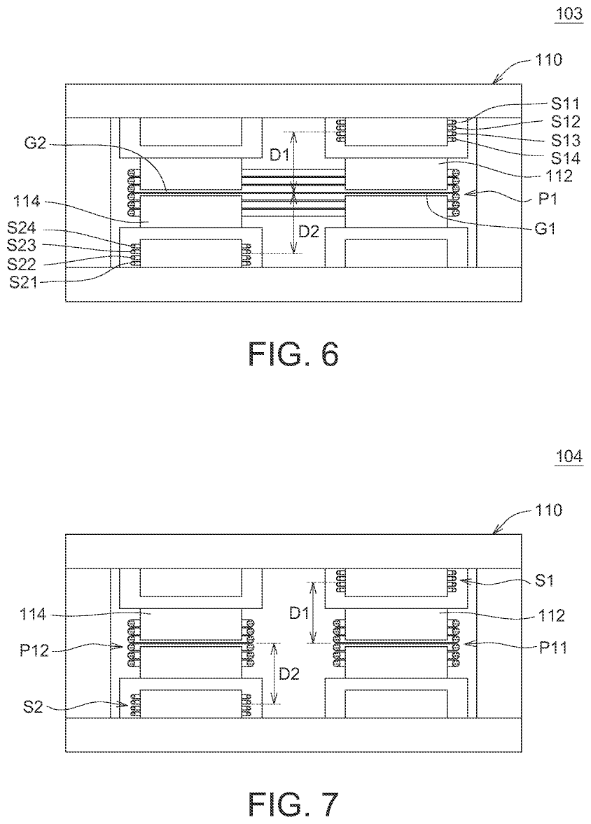

Refer to FIG. 6. A schematic cross-sectional view of the winding structure of the transformer 103 according to another embodiment of the present invention is illustrated. The difference between this embodiment and the above embodiment is that the first secondary winding set S1 located on the upper side includes parallel-connected first sub-windings S11 and S13 and parallel-connected second sub-windings S12 and S14. The parallel-connected first sub-windings S11, S13 and the parallel-connected second sub-windings S12, S14 are wound around the first winding post 112 and arranged in a staggered manner. In addition, the second secondary winding set S2 located on the lower side includes parallel-connected third sub-windings S21, S23 and parallel-connected fourth sub-windings S22, S24, wherein the parallel-connected third sub-windings S21 and S23 and the parallel-connected fourth sub-winding S22 and S24 are wound around the second winding post 114 and arranged in a staggered manner. That is to say, the first winding post 112 and the second winding post 114 respectively have multiple sub-windings. The first secondary winding set S1 located on the upper side has a first spacing D1 from the primary winding set P1, and the second secondary winding set S2 located on the lower side has a second spacing D2 from the primary winding set P1. The ratio of the first spacing D1 to the second spacing D2 is greater than or equal to 0.9 and less than or equal to 1.1 to balance the coupling coefficients.

Refer to FIG. 7. A schematic cross-sectional view of the winding structure of a transformer 104 according to another embodiment of the present invention is illustrated. The difference between this embodiment and the above embodiments is that the first secondary winding set S1 located on the upper side is wound around the first winding post 112, and the second secondary winding set S2 located on the lower side is wound around the second winding post 114, and the primary winding set P1 includes a first winding part P11 and a second winding part P12 connected in series, wherein the first winding part P11 is wound around the first winding post 112, and the second winding part P12 is wound around the second winding post 114, the first secondary winding set S1 on the upper side has a first spacing D1 from the first winding part P11, and the secondary winding S2 on the lower side P12 has a second spacing D2 from the second winding part P12. The ratio of the first spacing D1 to the second spacing D2 is greater than or equal to 0.9 and less than or equal to 1.1 to balance the coupling coefficients.

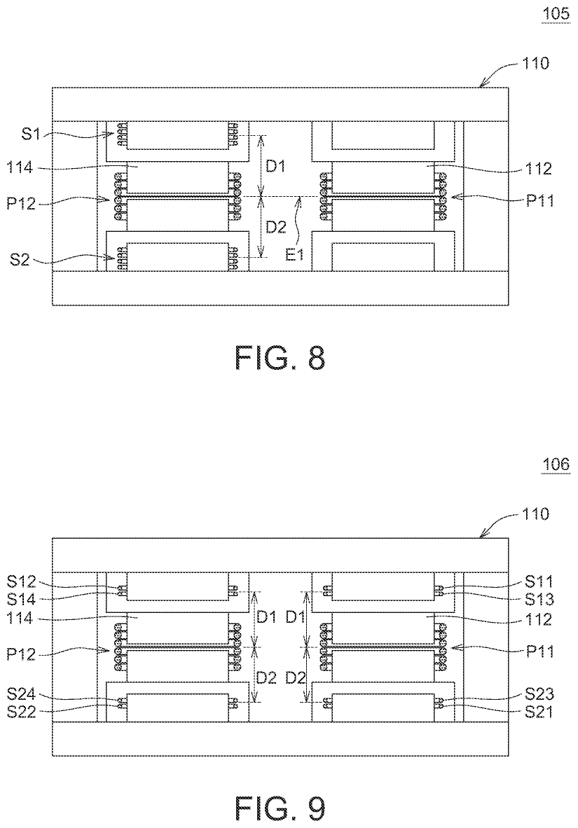

Refer to FIG. 8. A schematic cross-sectional view of the winding structure of a transformer 105 according to another embodiment of the present invention is illustrated. The difference between this embodiment and the above embodiments is that the first secondary winding set S1 located on the upper side is wound around the second winding post 114, and the second secondary winding set S2 located on the lower side is wound around the second winding post 114, and the primary winding set P1 includes a first winding part P11 and a second winding part P12 connected in series, wherein the first winding part P11 is wound around the first winding post 112, and the second winding part P12 is wound around the second winding post 114, the first secondary winding set S1 on the upper side has a first spacing D1 from the second winding part P12, and the second secondary winding set S2 on the lower side has a second spacing D2 from the second winding part P12. The ratio of the first spacing D1 to the second spacing D2 is greater than or equal to 0.9 and less than or equal to 1.1 to balance the coupling coefficients. In the same way, the first secondary winding set S1 located on the upper side has a minimum first spacing D1 from the first winding part P11 in an extension direction E1 of the winding direction of the first winding part P11, and the second secondary winding set S2 located on the lower side has a minimum second spacing D2 from the first winding part P11 in the extension direction E1 of the winding direction of the first winding part P11. The ratio of the first spacing D1 to the second spacing D2 is greater than or equal to 0.9 and less than or equal to 1.1 to balance the coupling coefficients. In this embodiment, the above-mentioned winding direction is the radial direction of the first winding post 112, and the minimum first and second spacings D1 and D2 refer to the minimum distance between the first and second secondary winding sets S1 and S2 and the first winding part P11 or the minimum distance perpendicular to the extending direction E1 of the winding direction of the first winding part P11.

Refer to FIG. 9. A schematic cross-sectional view of the winding structure of a transformer 106 according to another embodiment of the present invention is illustrated. The difference between this embodiment and the above embodiments is that the first secondary winding set S1 located on the upper side includes parallel-connected first sub-windings S11 and S13 and parallel-connected second sub-windings S12 and S14. The parallel-connected first sub-winding S11 and S13 are wound around the first winding post 112, and the parallel-connected second sub-windings S12 and S14 are wound around the second winding post 114. In addition, the second secondary winding set S2 located on the lower side includes parallel-connected third sub-windings S21 and S23 and parallel-connected fourth sub-windings S22 and S24, wherein the parallel-connected third sub-windings S21 and S23 are wound around the first winding post 112, and the parallel-connected fourth sub-windings S22 and S24 are wound around the second winding post 114. In addition, the primary winding set P1 includes a first winding part P11 and a second winding part P12 connected in series, wherein the first winding part P11 is wound around the first winding post 112 and the second winding part P12 is wound around the first winding post 114. The first sub-windings S11, S13 have a first spacing D1 from the first winding part P11, the third sub-windings S21, S23 have a second spacing D2 from the first winding part P11, and the second sub-windings S12, S14 have a first spacing D1 from the second winding part P12, the fourth sub-windings S22, S24 have a second spacing D2 from the second winding part P12. The ratio of the first spacing D1 to the second spacing D2 is greater than or equal to 0.9 and less than or equal to 1.1 to balance the coupling coefficients.

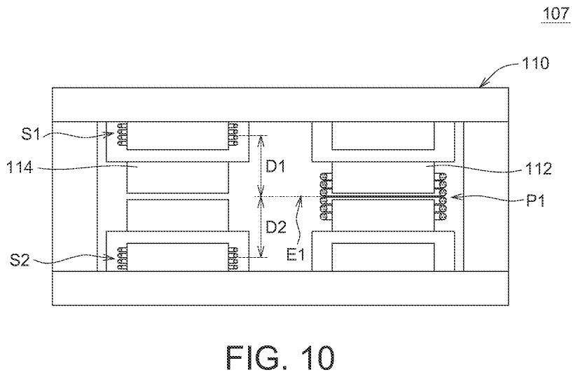

Refer to FIG. 10. A schematic cross-sectional view of the winding structure of a transformer 107 according to another embodiment of the present invention is illustrated. The difference between this embodiment and the above-mentioned embodiments is that the first secondary winding set S1 located on the upper side is wound around the second winding post 114, and the second secondary winding set S2 located on the lower side is wound around the second winding post 114, and the primary winding set P1 is wound around the first winding post 112. That is to say, the primary winding set P1 and the first and second secondary winding sets S1 and S2 are not on the same winding post, but are respectively located on the first winding post 112 and the second winding post 114, the first secondary winding set S1 located on the upper side has a minimum first spacing D1 from the first winding set P1 in an extension direction E1 of the winding direction of the first winding set P1, and the second secondary winding set S2 located on the lower side has a minimum second spacing D2 from the first winding set P1 in the extension direction E1 of the winding direction of the first winding set P1. The ratio of the first spacing D1 to the second spacing D2 is greater than or equal to 0.9 and less than or equal to 1.1 to balance the coupling coefficients. In this embodiment, the above-mentioned winding direction is the radial direction of the first winding post 112, and the minimum first and second spacings D1 and D2 refer to the minimum distance between the first and second secondary winding sets S1 and S2 and the first winding set P1 or the minimum distance perpendicular to the extending direction E1 of the winding direction of the first winding set P1.

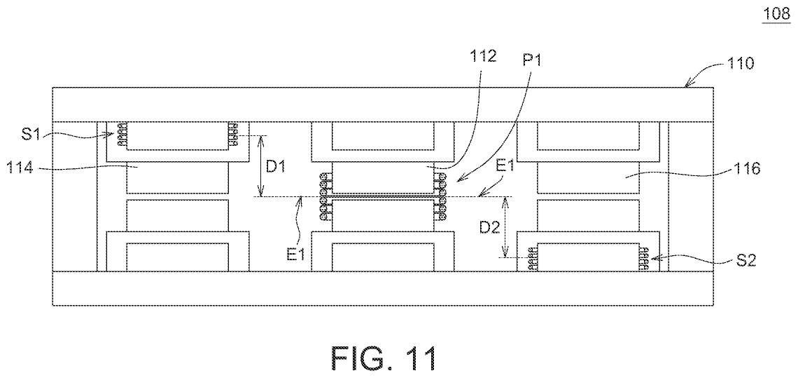

Refer to FIG. 11. A schematic cross-sectional view of the winding structure of a transformer 108 according to another embodiment of the present invention is illustrated. The difference between this embodiment and the above embodiments is that the magnetic core 110 includes a first winding post 112, a second winding post 114 and a third winding post 116. The first winding post 112, the second winding post 114 and the third winding post 116 are located between the upper cover 111 and the lower cover 113. The primary winding set P1 is wound around the first winding post 112, the first secondary winding set S1 on the upper side is wound around the second winding post 114, and the second secondary winding set S2 on the lower side is wound around the third winding post 116. That is to say, the primary winding set P1 and the first and second secondary winding sets S1 and S2 are respectively located on different winding posts. The first secondary winding set S1 located on the upper side has a minimum first spacing D1 from the first winding set P1 in an extension direction E1 of the winding direction of the first winding set P1, and the second secondary winding set S2 located on the lower side has a minimum second spacing D2 from the first winding set P1 in the extension direction E1 of the winding direction of the first winding set P1. The ratio of the first spacing D1 to the second spacing D2 is greater than or equal to 0.9 and less than or equal to 1.1 to balance the coupling coefficients.

It can be seen that the transformer of the above embodiments of the present invention can be applied in the structure of a center-tapped transformer, in which the first and second secondary winding sets are respectively arranged on opposite sides of the primary winding set, the first and second secondary winding sets and the primary winding set can be located on the same winding post or different winding posts. In addition to balancing the coupling coefficients, it can also make the peak values of the DC output in the positive and negative half cycles similar to improve the current flow issues and reduce power loss (copper loss).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A transformer comprising:
a magnetic core having an upper cover, a lower cover and a first winding post, the first winding post being located between the upper cover and the lower cover;
a primary winding set being wound around the first winding post;
a first secondary winding set being wound around the first winding post and being located on one side of the primary winding set; and
a second secondary winding set being wound around the first winding post and being located on another side of the primary winding set, wherein the second secondary winding set and the first secondary winding set are electrically connected and form a center-tapped structure.

2. The transformer according to claim 1, wherein the first winding post has an air gap, and the primary winding set overlaps the air gap.

3. The transformer according to claim 1, wherein the first secondary winding set has a first spacing from the primary winding set in an extending direction of the first winding post, the second secondary winding set has a second spacing from the primary winding set in the extending direction of the first winding post, and a ratio of the first spacing to the second spacing is greater than or equal to 0.9 and less than or equal to 1.1.

4. The transformer according to claim 1, wherein the magnetic core further comprises a second winding post, and the primary winding set is wound around the second winding post.

5. The transformer according to claim 4, wherein the first secondary winding set and the second secondary winding set are wound around the second winding post.

6. The transformer according to claim 1, wherein the primary winding set is electrically connected to a resonant circuit.

7. The transformer according to claim 1, further comprising:
a winding frame set on the first winding post and having a first accommodation area, a second accommodation area and a third accommodation area, and the first accommodation area being located between the second accommodation area and the third accommodation area, wherein the primary winding set is wound in the first accommodation area, the first secondary winding set is wound in the second accommodation area, and the second secondary winding set is wound in the third accommodation area.

8. The transformer according to claim 1, wherein the first secondary winding set has a plurality of parallel-connected sub-windings, and the second secondary winding set has a plurality of parallel-connected sub-windings.

9. A transformer comprising:
a magnetic core having an upper cover, a lower cover, a first winding post and a second winding post, the first winding post and the second winding post being located between the upper cover and the lower cover;
a primary winding set being wound around the first winding post;
a first secondary winding set being wound around the first winding post or the second winding post and being located on one side of the primary winding set; and
a second secondary winding set being wound around the first winding post or the second winding post and being located on another side of the primary winding set, wherein the second secondary winding set and the first secondary winding set are electrically connected and form a center-tapped structure.

10. The transformer according to claim 9, wherein the first secondary winding set has a minimum first spacing from the primary winding set or from an extending direction of a winding direction of the primary winding set, the second secondary winding set has a minimum second spacing from the primary winding set or from the extension direction of the winding direction of the primary winding set, a ratio of the first spacing to the second spacing is greater than or equal to 0.9 and less than or equal to 1.1, and the winding direction is a radial direction of the first winding post.

11. The transformer according to claim 9, wherein the first secondary winding set and the second secondary winding set are electrically connected to a rectifier circuit.

12. A transformer comprising:
a magnetic core having an upper cover, a lower cover, a first winding post, a second winding post and a third winding post, the first winding post, the second winding post and the third winding post being located between the upper cover and the lower cover;
a primary winding set being wound around the first winding post;
a first secondary winding set being wound around the second winding post and being located on one side of the primary winding set; and
a second secondary winding set being wound around the third winding post and being located on another side of the primary winding set, wherein the second secondary winding set and the first secondary winding set are electrically connected and form a center-tapped structure.

13. The transformer according to claim 12, wherein the first secondary winding set has a minimum first spacing from the primary winding set or from an extending direction of a winding direction of the primary winding set, the second secondary winding set has a minimum second spacing from the primary winding set or from the extension direction of the winding direction of the primary winding set, a ratio of the first spacing to the second spacing is greater than or equal to 0.9 and less than or equal to 1.1, and the winding direction is a radial direction of the first winding post.
